(19) United States
(12) Patent Application Publication
(10) Pub. No.: US 2024/0152920 A1
(43) Pub. Date: May 9, 2024

(54) SYSTEMS AND METHODS FOR PAYMENT USING BIOMETRIC INFORMATION

(71) Applicant: AMERICAN EXPRESS TRAVEL RELATED SERVICES COMPANY, INC., New York, NY (US)

(72) Inventors: Faraz Babar, Phoenix, AZ (US); Sathish B. Muthukrishnan, Phoenix, AZ (US)

(21) Appl. No.: 17/982,682

(22) Filed: Nov. 8, 2022

(51) Int. Cl. G06Q 20/40

(52) U.S. Cl. CPC G06Q 20/40145; G06Q 2220/00

(57) ABSTRACT

The systems and methods described herein generally relate to authorization requests using biometric information. The systems and methods may comprise operations performed by a computer based system comprising various components. The operations may include receiving biometric information from a user, identifying internal data for a user associated with the biometric information, identifying the internal data for the user associated with the biometric information and/or the user profile, analyzing the biometric information, authenticating the consumer in response to the analyzing the biometric information, and/or authorizing in response to the authenticating.

### BACKGROUND

Despite the various technologies allowing different payment methods, all transactions typically require the presentation and communication of the financial information of a consumer in order to pay for and complete a transaction.

### SUMMARY

A system, method, and article of manufacture (collectively, “the system”) are disclosed relating to payments using biometric information. In various embodiments, the system may be configured to perform operations including receiving, by a computer based system and from a point of interaction device, biometric information from a consumer as part of a transaction. The system may be capable of identifying, by the computer based system, a consumer profile associated with the biometric information. The system may further be capable of identifying, by the computer based system, a consumer account associated with the biometric information and/or the consumer profile.

In various embodiments, the system may be capable of analyzing, by the computer based system, the biometric information. The system may be capable of authenticating, by the computer based system, the consumer in response to the analyzing the biometric information. The system may be further capable of authorizing, by the computer based system, the transaction in response to the authenticating the consumer. The system may be further capable of sending, by the computer based system and to the point of interaction device, an authorization response in response to the authorizing the transaction.

In various embodiments, the identifying the consumer profile may be completed via an identification database. The identifying the consumer account may be completed via a payment account database. The analyzing the biometric information may be completed via a transaction authorization and processing system and database (“TAPSD”). The authenticating the consumer may be completed via the TAPSD. The authorizing the transaction may be completed via the TAPSD.

In various embodiments, the biometric information may comprise a fingerprint, handprint, facial structure, and/or retinal structure. Identifying the consumer account may comprise identifying a digital token, transaction account information, and/or a user device comprising the consumer account that is associated with the consumer profile. The authorization response may be a payment token and/or a response code. The authorization response may be transient. Analyzing the biometric information may comprise comparing, by the computer based system and via the TAPSD, the biometric information to a biometric credential associated with the consumer profile and/or consumer account.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1A shows an exemplary payment system diagram, in accordance with various embodiments;

FIG. 1B shows an exemplary illustration of a point of sale system, in accordance with various embodiments;

FIG. 2A shows a flowchart depicting an exemplary process for authorizing a transaction using biometric information, in accordance with various embodiments; and

FIG. 2B shows a flowchart depicting an exemplary process for processing a transaction using biometric information, in accordance with various embodiments.

### DETAILED DESCRIPTION

The present disclosure generally relates to payment for a transaction using biometric information provided by a consumer. The detailed description of various embodiments herein makes reference to the accompanying drawings, which show the exemplary embodiments by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

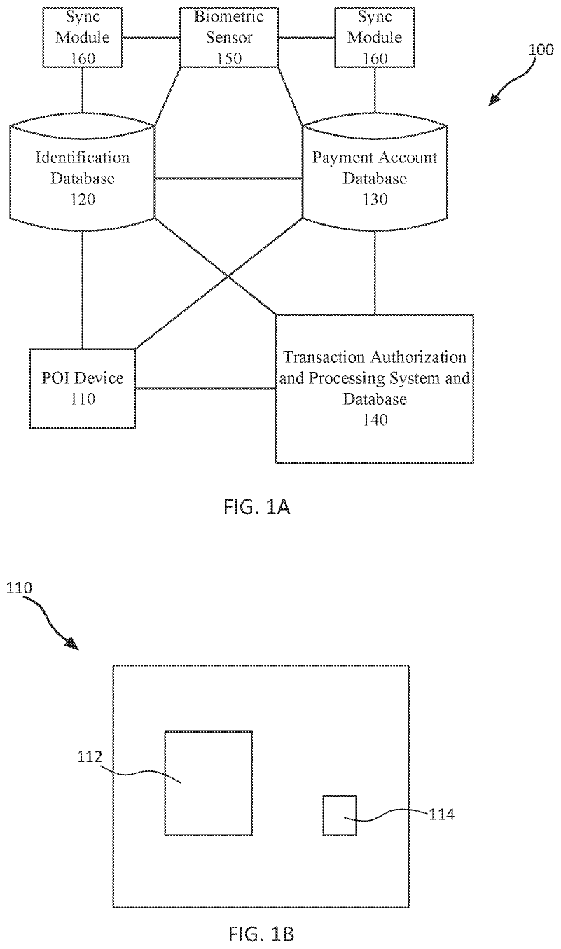

In various embodiments, and with reference to FIG. 1A, an exemplary payment system 100 for paying for and completing a transaction using biometric information is disclosed. System 100 may comprise a point of interaction (“POI”) device 110, an identification database 120, a payment account database 130, a TAPSD 140, a biometric sensor 150, and/or one or more sync modules 160. System 100 may be computer based, and may comprise a processor, a tangible non-transitory computer-readable memory, and/or a network interface. Instructions stored on the tangible non-transitory memory may allow system 100 to perform various functions, as described herein.

In various embodiments, POI device 110 may incorporate hardware and/or software components. For example, POI device 110 may comprise a server appliance running a suitable server operating system (e.g., MICROSOFT INTERNET INFORMATION SERVICES or, “IIS”). POI device 110 may be any device that allows a user to communicate with a network and/or conduct a transaction (e.g., a point of sale device, a personal digital assistant (e.g., IPHONE®, BLACKBERRY®), cellular phone, kiosk, and/or the like). POI device 110 may be in electronic communication with identification database 120, payment account database 130, and/or TAPSD 140. POI device 110 may participate in any or all of the functions performed by identification database 120, payment account database 130, and/or TAPSD 140.

In various embodiments, and with reference to FIG. 1B, POI device 110 may comprise, for interfacing with a consumer, a display 112 and/or an identity reader 114. Display 112 may be in electronic communication with a processor and configured to present information to a consumer. Identity reader 114 may be in electronic communication with the processor and configured to receive identifier information from a consumer. Identity reader 114 may be any suitable identify detection device. For example, identity reader 114 may be a biometric scanner, and/or the like, configured to receive biometric information from a consumer. Biometric information, as a form of identifier information may include a user's voice, fingerprint, handprint, facial structure, ear, signature, vascular patterns, DNA sampling, hand geometry, sound, olfactory, keystroke/typing, iris structure, retinal structure, and/or any other biometric relating to recognition based upon any body part, function, system, attribute and/or other characteristic, or any portion thereof.

Returning to FIG. 1A, in various embodiments, identification database 120 may comprise hardware and/or software capable of storing data. For example, identification database 120 may comprise a server appliance running a suitable server operating system (e.g., MICROSOFT INTERNET INFORMATION SERVICES or, “IIS”) and having database software (e.g., ORACLE) installed thereon. Identification database 120 may be in electronic communication with POI device 110, payment account database 130, TAPSD 140, a sync module 160, and/or biometric sensor 150. In various embodiments, identification database 120 may store one or more consumer profiles. In various embodiments, the identification database 120 may also store account indicia associated with one or more consumer profiles, such as a digital token, a transaction account, a consumer device, biometric information and/or credentials, and/or the like.

In various embodiments, payment account database 130 may comprise hardware and/or software capable of storing data. For example, payment account database 130 may comprise a server appliance running a suitable server operating system (e.g., MICROSOFT INTERNET INFORMATION SERVICES or, “IIS”) and having database software (e.g., ORACLE) installed thereon. Payment account database 130 may be in electronic communication with POI device 110, identification database 120, TAPSD 140, a sync module 160, and/or biometric sensor 150. In various embodiments, payment account database 130 may store a consumer account, or multiple consumer accounts (e.g., a payment account, credit card account, transaction account, and/or the like). Payment account database 130 may also store account indicia associated with the consumer account (e.g., a digital token, transaction account information, a consumer device, biometric information and/or credentials, and/or the like). In various embodiments, information stored in payment account database 130 and identification database 120 may be comprised within a single database. In various embodiments, the consumer profile for a consumer may be comprised within the consumer's consumer account, and/or the consumer account for a consumer may be comprised within the consumer's consumer profile.

In various embodiments, TAPSD 140 may comprise hardware and/or software capable of storing data and/or analyzing information. For example, TAPSD 140 may comprise a server appliance running a suitable server operating system (e.g., MICROSOFT INTERNET INFORMATION SERVICES or, “IIS”) and having database software (e.g., ORACLE) installed thereon. TAPSD 140 may store financial information for one or more consumer accounts. TAPSD 140 may be configured to analyze biometric information and authenticate (via electronic communication with POI device 110, identification database 120, and/or payment account database 130) the identity of the consumer providing biometric information. Analyzing the biometric information and authenticating the consumer may comprise TAPSD 140 comparing and/or matching consumer biometric information with a consumer profile and/or consumer account, and/or comparing and/or matching the biometric information with a biometric credential associated with a consumer profile and/or consumer account. TAPSD 140 may be configured to authorize or deny a response, and send an authorization response to POI device 110 that either authorizes or denies a transaction in response to analyzing the biometric information.

In various embodiments, biometric sensor 150 may incorporate hardware and/or software components configured to receive and obtain a biometric credential from a consumer. Biometric sensor 150 may be in electronic communication with identification database 120, payment account database 130, and/or sync modules 160. Biometric sensor 150 may be configured to receive and/or obtain a biometric credential from a consumer that will be associated with a consumer profile and/or a consumer account associated with the consumer. The biometric credential may be a user's voice, fingerprint, handprint, facial structure, ear, signature, vascular patterns, DNA sampling, hand geometry, sound, olfactory, keystroke/typing, iris structure, retinal structure, and/or any other biometric relating to recognition based upon any body part, function, system, attribute and/or other characteristic, or any portion thereof. The biometric credential may be pre-stored by the system and used by system 100 to compare and match biometric information provided by the consumer in response to conducting and/or completing a transaction.

In various embodiments, sync modules 160 may comprise hardware and/or software configured to receive a biometric credential from biometric sensor 150 and associate (and/or sync) the biometric credential with a consumer profile and/or consumer account associated with the consumer. The synced biometric credential may be stored with the consumer profile in identification database 120 and/or with the consumer account in payment account database 130. In response to sync modules 160 syncing or associating the biometric credential with a consumer profile and/or consumer account, the biometric credential may serve as identifier information to associate a consumer with the consumer profile and/or consumer account in response to the consumer producing biometric information, in response to conducting or completing a transaction, that matches the biometric credential.

Terms and phrases similar to “sync,” “syncing,” and/or “synchronizing” may include associating, tagging, flagging, correlating, using a look-up table or any other method or system for indicating or creating a relationship between elements such as, for example (i) a consumer account and (ii) a biometric credential. Moreover, the sync may occur at any point at which a biometric credential is provided to biometric sensor 150 and sync modules 160.

Terms and phrases similar to “associate” and/or “associating” may include tagging, flagging, correlating, using a look-up table or any other method or system for indicating or creating a relationship between elements, such as, for example, (i) a consumer account and (ii) a biometric credential. Moreover, the associating may occur at any point at which a biometric credential is provided to biometric sensor 150 and sync modules 160.

The various components in system 100 may be independently and separately or collectively suitably coupled to each other, and/or the network, via data links which include, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

In operation, a consumer may initiate a transaction with system 100 and present biometric information to identity reader 114 of POI device 110, for example, in response to being asked to pay for the transaction. System 100 may have previously obtained a biometric credential from the consumer via biometric sensor 150, and synced and/or associated the biometric credential with the consumer's consumer profile and/or consumer account through sync modules 160. The synced biometric credential may be stored with the consumer profile and/or consumer account in identification database 120 and/or payment account database 130, respectively.

In various embodiments, POI device 110 may receive the biometric information via the identity reader 114, and system 100 may receive the biometric information from POI device 110. System 100 may access identification database 120 and identify a consumer profile associated with the biometric information and/or a consumer account. System 100 may access payment account database 130 and identify a consumer account associated with the consumer profile and/or the biometric information. In various embodiments, identifying the consumer account may comprise identifying account indicia in the consumer account, such as a digital token, transaction account information, and/or a user device, associated with the consumer profile. In various embodiments, identifying the consumer profile and/or the consumer account may take place at different times or simultaneously, in any order. POI device 110 (and/or any other component of system 100) may request authorization for the transaction in response to the consumer account and/or the consumer profile being identified. As part of the request, POI device 110 (and/or any other component of system 100) may send account indicia (e.g., biometric information, a digital token, and/or the like) associated with the consumer profile (received from identification database 120) and/or the consumer account (received from payment account database 130) to TAPSD 140.

In various embodiments, TAPSD 140 may analyze the biometric information by matching or comparing the biometric information provided by the consumer with the biometric credential associated or synced with the consumer account and/or consumer profile to authenticate the consumer. In response to the biometric information matching the biometric credential, TAPSD 140 may authenticate the consumer conducting the transaction. If the biometric information does not match the biometric credential, TAPSD 140 may not authenticate the consumer. TAPSD 140 may authorize (or deny) the transaction in response to authenticating (or failing to authenticate) the consumer. TAPSD 140 may send an authorization response in response to the consumer authentication. POI device 110 may receive an authorization response from TAPSD 140. The authorization response may be a payment token, a response code, and/or the like.

In various embodiments, the operations performed by TAPSD 140 (i.e., analyzing the biometric information, authenticating the consumer, and/or authorizing the transaction) may be performed by the same party or one or more third parties different from the party storing and/or identifying the consumer profile and/or consumer account. In fact, each operation performed by TAPSD 140 may be performed by the same party or a different third party.

In various embodiments, system 100 may be configured to prevent the flow of a consumer's financial information during a transaction. Stated another way, system 100 in operation, as described above, may require only biometric information provided to POI device 110 by a consumer, as credentials to pay for and approve a transaction. Therefore, the consumer simply uses biometric information, rather than financial information, such as a credit card, credit card information, an account number, and/or the like, to complete the transaction. System 100 may obtain all of the information necessary for the transaction (consumer profile, consumer account, and associated information) without using any actual financial information. TAPSD 140 may be configured to identify financial information associated with the biometric information, consumer account, and/or the like, but prevent the flow the financial information, responding with, instead, an authorization response that may be some payment token, response code, either of which may be transient, and/or any response that approves the transaction without revealing the financial information of the consumer.

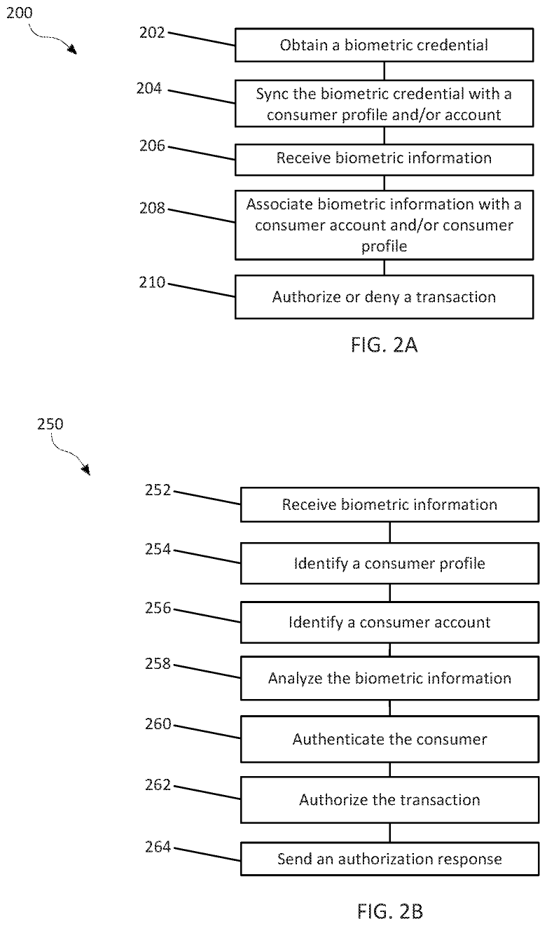

With combined reference to FIGS. 1A, 1B, and 2A, the systems, modules, and components described may be configured to perform a method 200 for authorizing a transaction using biometric information. Accordingly, in various embodiments, system 100 may obtain a biometric credential (step 202) from a consumer. The biometric credential may be any of the features discussed above in the description of biometric sensor 150. The consumer may present the biometric credential to a biometric sensor 150, and biometric sensor 150 may receive and send the biometric credential to one or more sync modules 160. Sync modules 160 may associate or sync the biometric credential with a consumer profile and/or consumer account (step 204) associated with the consumer.

In various embodiments, the system 100 may receive biometric information (step 206) from the consumer, for example, in response to the consumer to completing or paying for a transaction. The consumer may provide, and system 100 may receive, the biometric information through POI device 110. TAPSD 140 may compare, match, and/or associate the biometric information with a consumer account and/or consumer profile (step 208). TAPSD 140 may compare, match, and/or associate the biometric information with the consumer account and/or consumer profile by comparing the biometric information from the consumer with the biometric credential associated with the consumer account and/or consumer profile. In various embodiments, the comparing, matching, and/or associating of the biometric information with the biometric credential, consumer profile, and/or consumer account may be performed by the identification database 120 and/or the payment account database 130.

In various embodiments, in response to the biometric information matching the biometric credential, and therefore being associated with the consumer account and/or consumer profile, TAPSD 140 may authorize the transaction (step 210). Authorization may take place by the TAPSD 140 sending an authorization response to POI device 110. The authorization response may be a payment token, response code, and/or the like, which may be transient. In response to the biometric information not matching the biometric credential, and therefore not being associated with the consumer account and/or consumer profile, TAPSD 140 may deny the transaction (step 210).

With combined reference to FIGS. 1A, 1B, and 2B, the systems, modules, and components described may be configured to perform a method 250 for processing a transaction using biometric information. In various embodiments, biometric information may be received from a consumer (step 252). Identity reader 114 of POI device 110 may obtain the biometric information from the consumer, for example, in response to a request to pay for and/or complete a transaction. System 100 may receive the biometric information from POI device 110. In various embodiments, system 100 may identify a consumer profile (step 254) associated with the biometric information and/or a consumer account by accessing identification database 120. For example, identification database 120 may compare the biometric information received from the consumer with a biometric credential associated with the consumer profile. In response to the biometric information matching the biometric credential, identification database 120 may identify the consumer profile. In various embodiments, system 100 may identify a consumer account (step 256) associated with the consumer profile and/or the biometric information by accessing payment account database 130. For example, payment account database 130 may compare the biometric information received from the consumer with a biometric credential associated with the consumer account. In response to the biometric information matching the biometric credential, payment account database 130 may identify the consumer account. In various embodiments, identifying the consumer account may comprise identifying account indicia in the consumer account, such as a digital token, transaction account information, and/or a user device, associated with the consumer profile.

In various embodiments, POI device 110, and/or any other component in system 100, may request authorization for the transaction in response to identifying the consumer profile and/or the consumer account. POI device 110 may send the request to TAPSD 140. POI device 110, and/or any other component in system 100, may send the biometric information received from the consumer, a digital token associated with the consumer profile and/or the consumer account, and/or the like as identifier information and/or account indicia to TAPSD 140 with the request. TAPSD 140 may receive the request from POI device 110 and analyze the biometric information (step 258). To analyze the biometric information, TAPSD 140 may compare and/or match the biometric information with the biometric credential associated with the consumer account and/or consumer profile. In response to a match between the biometric information and the biometric credential, TAPSD 140 may authenticate the consumer (step 260).

In various embodiments, TAPSD 140 may authorize the transaction (step 262) in response to TAPSD 140 authenticating the consumer. In response to authorizing the transaction, TAPSD 140 may send an authorization response (step 264) to the POI device 110. The authorization response may be a payment token, response code, and/or the like, and the authorization response may be transient. As discussed above, in various embodiments, the steps performed by TAPSD 140 may be performed by one or more third parties unrelated to the party storing and/or identifying the consumer profiles and/or consumer accounts.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Any communication, transmission and/or channel discussed herein may include any system or method for delivering content (e.g., data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor: a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g., WEB SPHERE, WEB LOGIC, JBOSS). In various embodiments, the server may include web servers (e.g., APACHE, IIS, GWS, SUN JAVA® SYSTEM WEB SERVER).

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies a consumer profile, consumer account, and/or a consumer. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device, online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g., Ipsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“l/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other sub sets.

As stated above, in various embodiments, the data can be stored without regard to a common format. However, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the standalone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a My SQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request Including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The systems and methods may be described herein in terms of functional block components, screen shots, optional selections and various processing steps. It should be appreciated that such functional blocks may be realized by any number of hardware and/or software components configured to perform the specified functions. For example, the systems may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the systems may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995): (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term, “user”, “end user”, “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the systems may be embodied as a customization of an existing system, an add-on product, a processing apparatus executing upgraded software, a standalone system, a distributed system, a method, a data processing system, a device for data processing, and/or a computer program product. Accordingly, any portion of the systems or a module may take the form of a processing apparatus executing code, an internet based embodiment, an entirely hardware embodiment, or an embodiment combining aspects of the internet, software and hardware. Furthermore, the systems may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The systems and methods are described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 2A and 2B, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2A and 2B, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium”, “non-transitory computer-readable memory”, and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

In various embodiments, the systems are configured with a biometric security system that may be used for providing biometric information as a form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of biometric information.

Phrases and terms similar to an “entity” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g., RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 26481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g., financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the consumer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

Therefore, the following is claimed:

1. A method of analyzing a first biometric identifier for data security, comprising:
receiving, from a point of interaction device, an encrypted authorization request;
decrypting the encrypted authorization request to obtain an authorization request, the authorization request comprising the first biometric identifier;
identifying internal data for a user based at least in part on the first biometric identifier;
determining that the first biometric identifier matches a second biometric identifier stored in association with the internal data for the user; and
sending an authorization response to the point of interaction device in response to determining that the first biometric identifier matches the second biometric identifier.

2. The method of analyzing the first biometric identifier for data security of claim 1, further comprising:
determining an identity of the point of interaction device;
determining that the identity of the point of interaction device is associated with the internal data for the user; and
sending the authorization response to the point of interaction device occurs additionally in response to determining that the identity of the point of interaction device is associated with the internal data for the user.

3. The method of analyzing the first biometric identifier for data security of claim 1, wherein the first biometric identifier comprises a facial structure obtained from a camera of the point of interaction device.

4. The method of analyzing the first biometric identifier for data security of claim 1, wherein the first biometric identifier comprises a fingerprint captured using a fingerprint reader of the point of interaction device.

5. The method of analyzing the first biometric identifier for data security of claim 1, wherein the first biometric identifier comprises a voiceprint captured using a microphone of the point of interaction device.

6. The method of analyzing the first biometric identifier for data security of claim 1, wherein the authorization response comprises a digital token that indicates authorization.

7. The method of analyzing the first biometric identifier for data security of claim 1, further comprising
receiving the second biometric identifier prior to receiving the authorization request; and
storing the second biometric identifier in association with the internal data for the user.

8. A system to analyze a first biometric identifier for data security, comprising:
a computing device comprising a processor and a memory; and
machine-readable instructions stored in the memory that, when executed by the processor, cause the computing device to at least:
receive, from a point of interaction device, an encrypted authorization request;
decrypt the encrypted authorization request to obtain an authorization request, the authorization request comprising the first biometric identifier;
identify internal data for a user based at least in part on the first biometric identifier;
determine that the first biometric identifier matches a second biometric identifier stored in association with the internal data for the user; and
send an authorization response to the point of interaction device in response to a determination that the first biometric identifier matches the second biometric identifier.

9. The system to analyze the first biometric identifier for data security of claim 8, wherein the machine-readable instructions, when executed by the processor, further cause the computing device to at least:
determine an identity of the point of interaction device;
determine that the identity of the point of interaction device is associated with the internal data for the user; and
send the authorization response to the point of interaction device occurs additionally in response to a determination that the identity of the point of interaction device is associated with the internal data for the user.

10. The system to analyze the first biometric identifier for data security of claim 8, wherein the first biometric identifier comprises a facial structure obtained from a camera of the point of interaction device.

11. The system to analyze the first biometric identifier for data security of claim 8, wherein the first biometric identifier comprises a fingerprint captured using a fingerprint reader of the point of interaction device.

12. The system to analyze the first biometric identifier for data security of claim 8, wherein the first biometric identifier comprises a voiceprint captured using a microphone of the point of interaction device.

13. The system to analyze the first biometric identifier for data security of claim 8, wherein the authorization response comprises a digital token that indicates authorization.

14. The system to analyze the first biometric identifier for data security of claim 8, wherein the machine-readable instructions, when executed by the processor, further cause the computing device to at least:
receive the second biometric identifier prior to receiving the authorization request; and
store the second biometric identifier in association with the internal data for the user.

15. A non-transitory, computer-readable medium to analyze a first biometric identifier for data security comprising machine-readable instructions that, when executed by a processor of a computing device, cause the processor to at least:
receive, from a point of interaction device, an encrypted authorization request;
decrypt the encrypted authorization request to obtain an authorization request, the authorization request comprising the first biometric identifier;
identify internal data for a user based at least in part on the first biometric identifier;
determine that the first biometric identifier matches a second biometric identifier stored in association with the internal data for the user; and
send an authorization response to the point of interaction device in response to a determination that the first biometric identifier matches the second biometric identifier.

16. The non-transitory, computer-readable medium to analyze the first biometric identifier for data security of claim 15, wherein the machine-readable instructions, when executed by the processor, further cause the computing device to at least:
determine an identity of the point of interaction device;
determine that the identity of the point of interaction device is associated with the internal data for the user; and
send the authorization response to the point of interaction device occurs additionally in response to a determination that the identity of the point of interaction device is associated with the internal data for the user.

17. The non-transitory, computer-readable medium to analyze the first biometric identifier for data security of claim 15, wherein the first biometric identifier comprises a facial structure obtained from a camera of the point of interaction device.

18. The non-transitory, computer-readable medium to analyze the first biometric identifier for data security of claim 15, wherein the first biometric identifier comprises a fingerprint captured using a fingerprint reader of the point of interaction device.

19. The non-transitory, computer-readable medium to analyze the first biometric identifier for data security of claim 15, wherein the first biometric identifier comprises a voiceprint captured using a microphone of the point of interaction device.

20. The non-transitory, computer-readable medium to analyze the first biometric identifier for data security of claim 15, wherein the authorization response comprises a digital token that indicates authorization.
